(19) United States
(12) Patent Application Publication
(10) Pub. No.: US 2007/0022081 A1
(43) Pub. Date: Jan. 25, 2007

(54) Record of data repository access

(76) Inventor: Gerd M. Ritter, Heidelberg (DE)

Correspondence Address: FISH & RICHARDSON, P.C., PO BOX 1022, MINNEAPOLIS, MN, 55440-1022, US

(21) Appl. No.: 11/184,613

(22) Filed: Jul. 19, 2005

(51) Int. Cl. G06F 17/30

(52) U.S. Cl. 707/1

(57) ABSTRACT

The disclosure relates to computer systems that include 1) a data repository containing several data records and 2) several executable application processes that can cause the computer system to access the data records. A method includes accessing a data record in a data repository, the access of the data record being caused by an application process that is being executed. An electronic record of the data record access is generated, indicating the data record that was accessed and the application process that caused the data record access to occur. The record may reflect data repository access(es) performed during a client-server roundtrip. User behavior may be registered to generate recommendations for improving a data repository access strategy.

### TECHNICAL FIELD

The description relates to electronically recording data record access and an application process that causes the data record access(es) to occur.

### BACKGROUND

Many computer systems include data repositories. Data repositories are used for storing and maintaining organized data such that it is accessible and can be used for various purposes in the computer system. A data repository such as a database may be organized as a collection of interrelated tables, one or more of which the system can access upon request by an application or a process being executed.

A data repository is created using some form of database model. The database model may define the structure of the data repository to be created and the nature of the information that it can contain. The database model is often created at an early stage, before creating or defining the specific program applications that are to make use of the data repository. There may also be defined or created a data repository access strategy that defines, given the particular database model, how the system should access the data repository. Thus, the specific program applications will be defined and created to conform to the access methods specified by the data repository access strategy. The data repository access strategy can be implemented through certain executable routines in a persistence layer between an application layer and the data repository.

Every access of the data repository takes more or less time to perform depending on the availability and response time of the data repository, the amounts and nature of data to be retrieved (or stored), to name a few examples. Generally, longer access times are disfavored if they result in a detectable delay, for example because a client device is temporarily rendered inactive until the access is complete. Even when data record accesses are relatively quick the delay can be noticeable if several accesses must be performed before control is returned to the client device (i.e., during a roundtrip between the client device and a server device holding the data repository). On one hand, if several data components are always read concurrently from the data repository, it may be desirable to speed up the access by combining the retrieval into a single step. On the other hand, this may increase the amount of data redundancy in the repository and may create a need for additional buffering memory. Moreover, it may make selective accesses or updates more difficult, because the update of one requires an update of the other, and the locking of one component requires locking of the other. Thus, the efficiency of a computer system that includes a data repository can depend on a compromise between constraints imposed by the database model and the data repository access strategy.

### SUMMARY

The invention relates to electronically recording one or more data record accesses.

In a first general aspect, the invention provides a method to be performed in a computer system that includes 1) a data repository containing several data records and 2) several executable application processes that can cause the computer system to access the data records. The method comprises accessing a data record in a data repository, the access of the data record being caused by an application process that is being executed. The method comprises generating an electronic record of the data record access indicating the data record that was accessed and the application process that caused the data record access to occur.

In selected embodiments, generating the electronic record comprises associating the data record access with an identifier for the application process that caused the data record access to occur. The data record access may occur during a roundtrip in the computer system, and generating the electronic record may comprise associating the data record access with the roundtrip. Where the application process subsequently includes information retrieved in the data record access in a screen displayed to a user, generating the electronic record may comprise associating the data record access with an identifier for the screen. Generating the electronic record may comprise associating the data record access with another data record access, the data record access and the other data record access having occurred within a predefined proximity of each other. The electronic record may be made available to a user for review. The electronic record may also indicate at least another application process that is hierarchically related to the application process. The electronic record may indicate the application process at more than one level of granularity. The electronic record may be updated over time to indicate multiple data records that have been accessed and application processes that have caused the multiple data records to be accessed. The method may comprise automatically determining whether the updated electronic record contains a predefined pattern. The predefined pattern may comprise the data record being accessed more than once during a roundtrip in the computer system. A predefined output may be made if the updated electronic record contains the predefined pattern, the predefined output being associated with the predefined pattern. The method may further comprise automatically determining whether information in the updated electronic record and in another electronic record contains a predefined pattern. The electronic record may indicate a use for which the data record is accessed.

In a second general aspect, the invention provides a computer program product comprising a record generation module. The computer program product is tangibly embodied in an information carrier. The record generation module generates an electronic record of a data record access being caused by an application process that is being executed, the electronic record indicating the data record that was accessed and the application process that caused the data record access to occur.

In selected embodiments, the computer program product further comprises an availability module that makes the electronic record available for analysis. The computer program product may further comprise an analytics module that determines whether the electronic record contains a predefined pattern. The analytics module may make a predefined output if the electronic record contains the predefined pattern, the predefined output being associated with the predefined pattern. The electronic record may be updated over time to indicate multiple data records that have been accessed and application processes that have caused the multiple data records to be accessed. The predefined pattern may relate to at least two of the multiple data records being accessed during a roundtrip in a computer system. The predefined pattern may relate to user behavior.

Advantages of the systems and techniques described herein may include any or all of the following: Creating a record that reflects a correlation between data repository accesses and the application process(es) by which they are caused; allowing analysis of the efficiency of a data repository access strategy or a repository data model; allowing analysis of data repository accesses that take place in different situations, like when an application has several user interfaces, or when the data repository is used in different industries; and providing a tracking functionality for detecting bottlenecks in a complex data management process.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 and FIG. 2 are block diagrams of a system that accesses a data repository and makes an electronic record of the access;

FIG. 3 is a flow chart of exemplary operations that the system shown in FIG. 1 and FIG. 2 can perform; and

FIG. 4 is a block diagram of a general computer system.

Like reference numerals in the various drawings indicate like elements.

### DETAILED DESCRIPTION

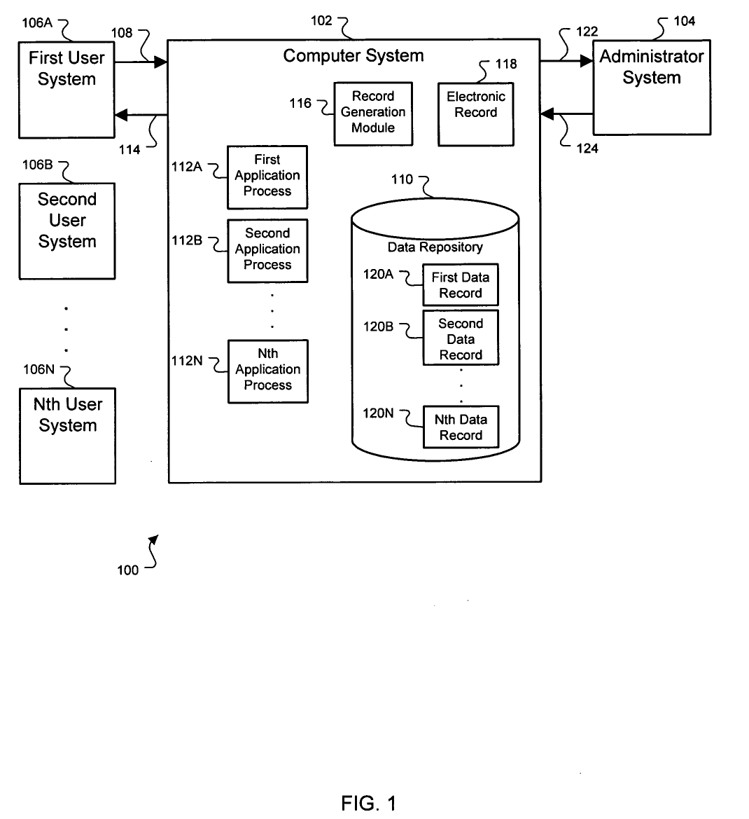

FIG. 1 shows a system 100 including a computer system 102, an administrator system 104, and one or more user systems 106. In the system 100, application processes access data residing in a repository on the computer system 102. The system 100 records data repository accesses electronically such that the electronic record indicates the data record that was accessed and an application process that caused the data repository access to occur. The electronic record can indicate the application process with any or all of different levels of granularity. A user of the administrator system 104 can analyze the electronic record to aid a determination of whether the strategy for accessing the repository is efficient or whether the model on which the repository is built can be improved, for example.

In the system 100, a user of one of the user systems requests data from an application process, as represented by arrow 108. In response, the application process retrieves the data from a data repository 110. The arrows 108 and 114 can represent a roundtrip in the system 100 during which the user system is inactive and awaits the response from the computer system. For example, a user of the first user system 106A may request that a report be displayed which requires a first application process 112A to retrieve data from the data repository 110. The first application process 112A accesses the data repository 110 and returns the report to the user, as represented by arrow 114. There may be many application processes (112A, 112B, . . . , 112N) capable of accessing the data repository 110. The application processes include application steps being executed, and any application process may be part of a session in the computer system. Thus, actions in the computer system are performed within a logical-entity hierarchy consisting of the specific executed step and a broader overall context in which the step is performed. Within this hierarchy there are different levels of granularity, for example such that the application process is hierarchically related to another application process. Any or all such levels of granularity can be relevant when analyzing data repository accesses.

When an application process accesses data in the data repository 110, a record generation module 116 saves information about the access in one or more electronic records 118. An application process may access one or more data records 120. For example, in generating the report for the user of the first user system 106A the first application process 112A may access a first data record 120A in the data repository 110. The record generation module 116 saves information about the access, such as an identity of the data record or data records accessed and the application process or application processes that accessed them, in the electronic record 118. The information placed in the electronic record can indicate the application process at any or all levels of granularity. For example, it may indicate the specific step being executed, the identity of the application process that includes the executed step, or it may identify a computer system session of which the application process is a part. FIG. 1 also contains items 122, and 124 that will be discussed later.

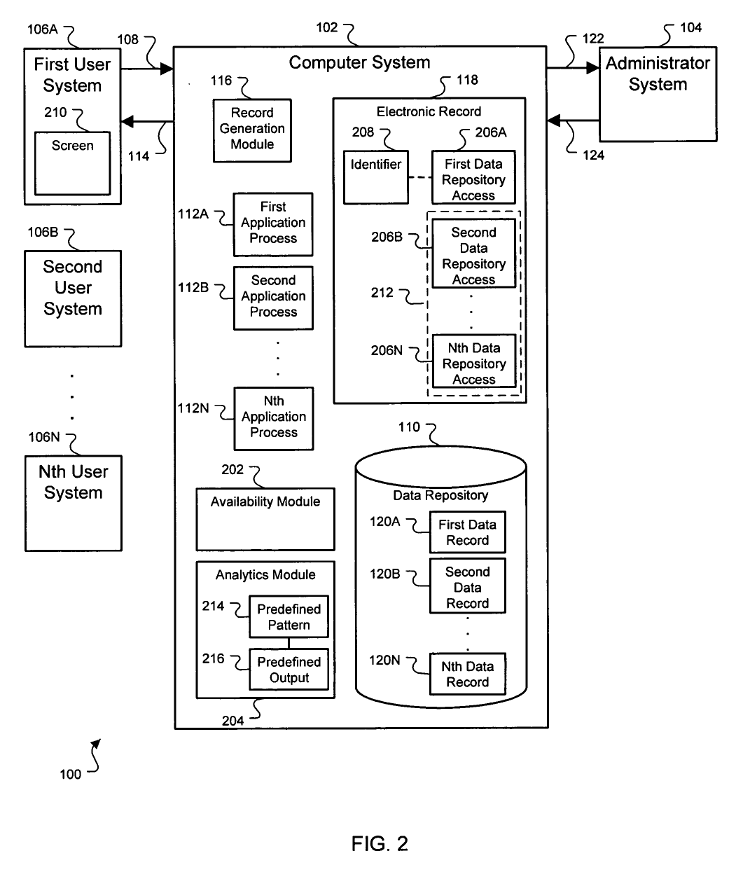

FIG. 2 shows an example of additional components in the system 100. FIG. 2 shows the computer system 102 including an availability module 202 for making the electronic record 118 available for analysis and an analytics module 204 for analyzing the electronic record 118, for example to determine whether it contains a predefined pattern.

The electronic record 118 indicates the data record accessed and the application process that caused the data record access to occur. When the record generation module 116 generates the electronic record 118, it may save a first data repository access 206A along with an identifier 208 of the application process that caused the data repository 110 to be accessed. For example, in generating the report for the user of the first user system 106A, it may be the first application process 112A that causes a first data record 120A in the data repository 110 to be accessed. The record generation module 116 may therefore save the first data repository access 206A and the identifier 208 of the first application process 112A in the electronic record 118. The electronic record 118 may use any form of electronic information persistence, such as a data file, a memory location or a database, to name a few examples.

The record generation module 116 may use other ways to identify in the electronic record the application process that caused the data repository access. If the first data repository access 206A occurred as part of a roundtrip in the system 100, such as a client-server roundtrip represented by the arrows 108 and 114, the record generation module 116 may associate the data repository access 206A with the roundtrip. For example, a user may request that the first application process 112A generate a report, as represented by arrow 108. The first application process 112A may access the first data record 120A and return the report to the user on a user interface screen 210 at the first user system 106, as represented by arrow 114. The record generation module 116 creates the electronic record 118, which may include the first data repository access 206A and may indicate the roundtrip for generating the report. For example, the identifier 208 may indicate the roundtrip.

As another example, the record generation module 116 may associate the first data repository access 206A with the user interface screen 210 that displays the first data record 120A. Particularly, the first application process 112A may access several data records in the data repository 110. The electronic record 118 may also include an association between the first data repository access 206A and any other data repository accesses that occurred within a predefined proximity in time to the first data repository access 206A. For example, the report being generated may also result in the second data record 120B through the Nth data record 120N being accessed and all of the accesses may occur within the predefined proximity. In this case, the electronic record 118 could also list the second data repository access 206B through the Nth data repository access 206N. Particularly, data repository accesses that relate to each other may be grouped together in the electronic record 118, as schematically indicated by the dashed line 212. This allows those data repository accesses to be identified as relating to a common roundtrip or as providing data for a single screen.

The system may identify retrieved data in the electronic record 118 based on its use. For example, the electronic record may identify some retrieved data as being retrieved for use “in user interface” and other data as being retrieved for use “in batch”. The “in user interface” identification means that the data is retrieved for presentation to a person that is reviewing or managing data using a UI. For data accesses labeled “in user interface,” the application process that causes the data record to be accessed relates to presentation of data to a user. The “in batch” alternative, in contrast, indicates that the data retrieval was triggered automatically, e.g. by an incoming purchasing request sent electronically from a purchasing system used by another company. For data accesses labeled “in batch,” the application process that causes the data record to be accessed relates to automatically forwarding a batch of data without the data necessarily being displayed. Such distinctions can be useful, upon analysis of the electronic record, in determining whether to modify the repository access strategy or the data model.

The system 100 may make the electronic record 118 available to a user of the administrator system 104 for analysis. More specifically, there may be in the computer system 102 the availability module 202, which makes the electronic record 118 available to the user of the administrator system 104. The administrator may analyze the electronic record 118 in order to improve the efficiency of accesses to the data repository 110. The administrator may retrieve the electronic record 110 for analysis, as represented by arrow 122, and make changes to the computer system 102 to improve the efficiency of access to the data repository 110, as represented by arrow 124. Such changes may involve modifying a database access strategy used for database access. For example, the administrator may decide that several data repository accesses that relate to a single roundtrip or that provide data for a single screen should be handled as a common data repository access, or that separate records should be combined into a single database table. Another example is that the data model can be changed.

The record generation module 116 may update the electronic record 118 over time to indicate multiple data records that have been accessed and application processes that have caused the multiple data records to be accessed. The analytics module 204 may automatically check for a predefined pattern 214 in the electronic record 118. If the predefined pattern 214 is found in the electronic record 118, a predefined output 216 associated with the predefined pattern 214 may be made. For example, the predefined pattern 214 may be the existence of a series of data accesses that occur during a single roundtrip. As another example, the predefined pattern 214 may comprise the data for a particular screen obtained through multiple data repository accesses. When the analytics module 204 identifies the predefined pattern 214 it may make the predefined output 216 that is associated with the predefined pattern 214. The predefined output 216 may be a recommendation for improving the database access strategy, for example. The predefined pattern 214 may also relate to the behavior of users in accessing the information retrieved from the data repository, such as a particular set of screens that the user viewed. For example, if the analytics module 204 determines that a sufficiently large proportion of users request data repository access 120B immediately upon data repository access 120A, the analytics module 204 can issue a recommendation (predefined output 216) that the two data repository accesses be handled together, such as by combining database tables into one.

The electronic record 118 allows analysis of how the system 100 accesses data records from the data repository 110. For example, if the user identifies information in the electronic record 118 indicating that data access could be improved, the user may take action to change the way that the data is accessed. Particularly, if a series of data repository accesses, represented by the data repository accesses enclosed by the dashed line 212, always occurs together, the user of the administrator system 104 may wish to ensure that those data repository accesses always occur as a single request to the data repository 110 or that the data model is changed such that the data is merged. This may improve the efficiency and performance of the accesses to the data repository 110. For example, these related data repository accesses, enclosed by the dashed line 212, may occur as part of a client-server roundtrip. In another example, when a user of a user system views a particular screen, that user typically views a second screen as well. The user of the administrator system 104 may wish to ensure that data repository accesses for both screens always occur as a single request to the data repository 110 to improve efficiency and performance. Here, each of the screen displays is associated with a separate roundtrip, and the electronic record may indicate the user session in which they take place, such as the creation of a sales order. Another example is that dashed line 212 encloses more than one data repository access that retrieves the same data from the repository. The identity of the several data repository accesses may be established by recording in the record 118 the key of the record(s) being accessed. The accessed data having the identified key may reside in two or more tables in the repository. Such redundant repository accesses indicate that there may be a problem with buffering at the application server. The analytics module 204 may also find possible areas of improvement by identifying the predefined pattern 214 contained in the electronic record 118.

More than one electronic record 118 may be created. For example, the several electronic records may relate to data repository accesses caused by different application processes, data repository accesses that involve different aspects of the data repository, or data repository accesses occurring at different times, to name a few examples. The analysis can be performed on several electronic records to determine whether the data repository accesses recorded therein form a predefined pattern.

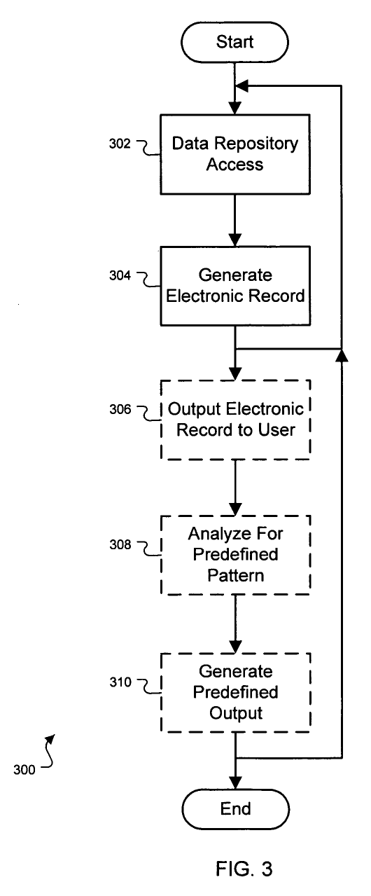

FIG. 3 is a flow chart of exemplary operations 300 that the system 100 can perform. A processor executing instructions stored in a computer program product can perform the operations 300. The operations 300 begin with accessing, in step 302, a data record in a data repository, the access of the data record being caused by an application process that is being executed. For example, in the system 100 of FIG. 1, the first application process 112A may cause the computer system 102 to access the first data record 120A in the data repository 110. Particularly, the user requests the data repository access (arrow 108) and the computer system provides the requested information (arrow 114).

In step 304, the system generates an electronic record of the data record access indicating the data record that was accessed and the application process that caused the data record access to occur. For example, the record generation module 116 of the system 100 may generate the electronic record 118 including the first data repository access 206A and the identifier 208 of the first application process 112A. The electronic record 118 may indicate the application process at any or all different levels of granularity, for example at a process step level, at an application level, at a session level, or at each of these levels.

Many data repository accesses may occur and the system may update the electronic record repeatedly. For example, in the system 100 the generation module 116 may update the electronic record 118 as more data repository accesses 206 occur. Thus, steps 302 and 304 may be performed once or more over time, such as for every data repository access that is done in the system.

Optionally, the operations 300 may comprise outputting, in step 306, the electronic record to the user for review. For example, the availability module 202 may provide the electronic record 118 to a user of the administrator system 104. This lets the user analyze whether improvements should be made in the strategy for accessing the data repository.

In another option, the system may automatically determine, in optional step 308, whether the updated electronic record contains a predefined pattern. For example, the analytics module 204 of system 100 may analyze the electronic record 118 in order to find the predefined pattern 214. If the electronic record contains the predefined pattern the system may generate, in optional step 310, a predefined output, the predefined output being associated with the predefined pattern. For example, in system 100 the analytics module 204 may generate the predefined output 216, such as a recommendation regarding the data repository access strategy. The system may repeat operation 306, 308, or 310, or several of them.

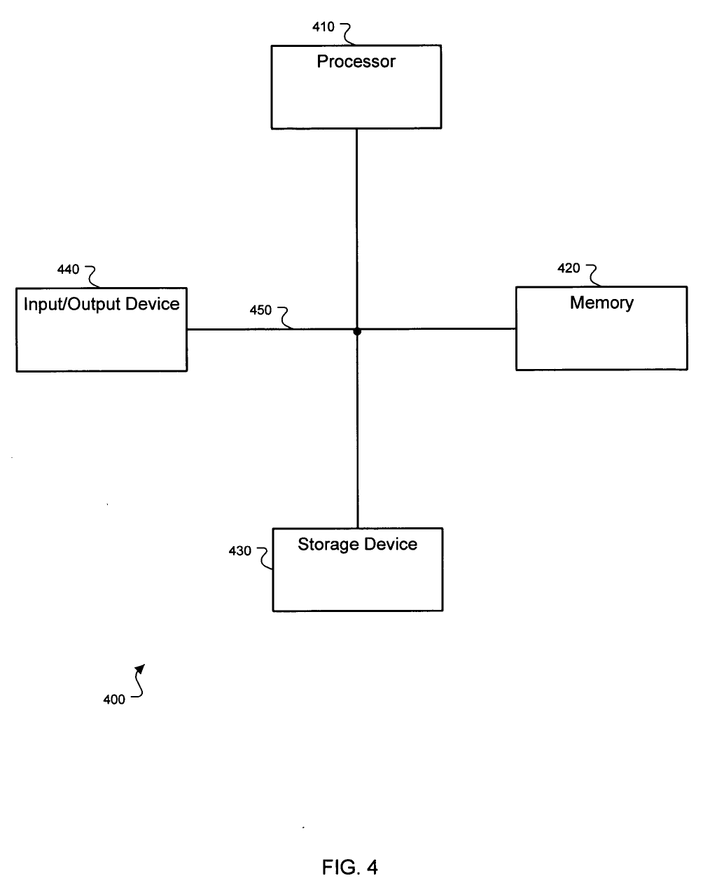

FIG. 4 is a block diagram of a computer system 400 that can be used in the operations described above, according to one embodiment. For example, the system 400 may be included in either or all of the computer system 102, the user systems 106, and the administrator system 104.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In one embodiment, the input/output device 440 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. In a computer system that includes 1) a data repository containing several data records and 2) several executable application processes that can cause the computer system to access the data records, a method comprising:
accessing a data record in a data repository, the access of the data record being caused by an application process that is being executed; and
generating an electronic record of the data record access indicating the data record that was accessed and the application process that caused the data record access to occur.

2. The method of claim 1, wherein generating the electronic record comprises associating the data record access with an identifier for the application process that caused the data record access to occur.

3. The method of claim 1, wherein the data record access occurred during a roundtrip in the computer system, and wherein generating the electronic record comprises associating the data record access with the roundtrip.

4. The method of claim 1, wherein the application process subsequently includes information retrieved in the data record access in a screen displayed to a user, wherein generating the electronic record comprises associating the data record access with an identifier for the screen.

5. The method of claim 1, wherein generating the electronic record comprises associating the data record access with another data record access, the data record access and the other data record access having occurred within a predefined proximity of each other.

6. The method of claim 1, further comprising making the electronic record available to a user for review.

7. The method of claim 1, wherein the electronic record also indicates at least another application process that is hierarchically related to the application process.

8. The method of claim 1, wherein the electronic record indicates the application process at more than one level of granularity.

9. The method of claim 1, wherein the electronic record is updated over time to indicate multiple data records that have been accessed and application processes that have caused the multiple data records to be accessed.

10. The method of claim 9, further comprising automatically determining whether the updated electronic record contains a predefined pattern.

11. The method of claim 10, wherein the predefined pattern comprises the data record being accessed more than once during a roundtrip in the computer system.

12. The method of claim 10, further comprising making a predefined output if the updated electronic record contains the predefined pattern, the predefined output being associated with the predefined pattern.

13. The method of claim 1, further comprising automatically determining whether information in the updated electronic record and in another electronic record contains a predefined pattern.

14. The method of claim 1, wherein the electronic record indicates a use for which the data record is accessed.

15. A computer program product tangibly embodied in an information carrier, the computer program product including instructions that, when executed, cause a processor to perform operations comprising:
accessing a data record in a data repository, the access of the data record being caused by an application process that is being executed; and
generating an electronic record of the data record access indicating the data record that was accessed and the application process that caused the data record access to occur.

16. A computer program product tangibly embodied in an information carrier, the computer program product comprising:
a record generation module that generates an electronic record of a data record access being caused by an application process that is being executed, the electronic record indicating the data record that was accessed and the application process that caused the data record access to occur.

17. The computer program product of claim 16, further comprising:
an availability module that makes the electronic record available for analysis.

18. The computer program product of claim 16, further comprising:
an analytics module that determines whether the electronic record contains a predefined pattern.

19. The computer program product of claim 18, wherein the analytics module makes a predefined output if the electronic record contains the predefined pattern, the predefined output being associated with the predefined pattern.

20. The computer program product of claim 19, wherein the electronic record has been updated over time to indicate multiple data records that have been accessed and application processes that have caused the multiple data records to be accessed, and wherein the predefined pattern relates to at least two of the multiple data records being accessed during a roundtrip in a computer system.

21. The computer program product of claim 19, wherein the electronic record has been updated over time to indicate multiple data records that have been accessed and application processes that have caused the multiple data records to be accessed, and wherein the predefined pattern relates to user behavior.
